(19) United States
(12) Patent Application Publication
(10) Pub. No.: US 2025/0242631 A1
(43) Pub. Date: Jul. 31, 2025

(54) ELASTIC WIRE CLIP ASSEMBLY FOR A WRITING PEN OR THE LIKE

(71) Applicant: Hangzhou Youtuo Creative Products Co. Ltd., Hangzhou (CN)

(72) Inventor: Hanqi Xu, Hangzhou (CN)

(21) Appl. No.: 18/939,763

(22) Filed: Nov. 7, 2024

(30) Foreign Application Priority Data
Jan. 31, 2024 (CN) 202410137965.9
Jan. 31, 2024 (CN) 202420234226.7
Feb. 29, 2024 (CN) 202410229536.4

(51) Int. Cl. B43K 25/02

(52) U.S. Cl. CPC B43K 25/024

(57) ABSTRACT

An elastic wire clip assembly includes a connection member and an elastic wire clip. The elastic wire clip includes at least one clamping section configured for clamping an object to the outer surface of a writing instrument or the like, at least one assembly section connected to an end portion of the clamping section, and at least one elastic transfer section connected to the assembly section. The elastic transfer section deforms when the clamping section is pressed outward from the outer surface of the writing instrument. A restoring elastic force from the deformed elastic transfer section counteracts the pressure. The elastic wire clip is formed by bending one steel wire. The connection member comprises a hanging wall and a blocking wall opposite the hanging wall to form a socket for receiving and retaining the elastic wire clip.

### CROSS-REFERENCE

This application claims priority to Chinese Patent Application No. 202420234226.7 filed on Jan. 31, 2024, Chinese Patent Application No. 202410137965.9 filed on Jan. 31, 2024, and Chinese Patent Application No. 202410229536.4 filed on Feb. 29, 2024. The contents of those application are incorporated herein by reference in their entirety.

### TECHNICAL FIELD

The present invention relates to retaining devices for small handheld objects, and in particular, to a an elastic wire clip assembly such as for a writing pen.

### BACKGROUND

This application relates to an elastic clip assembly for use with a writing instrument or similar device designed to clip to, for example, a shirt pocket. Chinese Patent CN204451628U discloses a retractable pen clip, including a pen clip base and an elastic sheet. Two ends of the elastic sheet abut against an upper limiting structure and a lower limiting structure in a sleeve respectively. One end of the pen clip base is fixed on the elastic sheet, and the other end extends out of the sleeve to be connected to the pen clip. The pen clip base is located in the middle of the elastic sheet. In the foregoing solution, the pen clip is a sheet structure. A U-shaped elastic force sheet is arranged between the pen clip and the pen clip base, which are all steel sheet structures, resulting in high processing and formation costs, high material usage, and high manufacturing costs.

Chinese Patent CN214984424U discloses a pen clip. One end of a pen clip body of the pen clip is a fixed end, and the other end is a clamping end. A steel wire is wound on a circumferential side face of the pen clip body. A part of the steel wire close to the fixed end is fixedly arranged, and a part of the steel wire close to the clamping end can swing along with the clamping end. The pen clip has a large clamping force and is not prone to breakage. However, the steel wire of the pen clip is bent to form a structure with two steel wires in parallel, and needs to cooperate with the pen clip body, resulting in high processing and manufacturing costs.

Chinese Patent CN210390569U discloses a clamping structure of a pen, including a steel wire. The middle of the steel wire is bent to form a clamping end. One end of the steel wire is rotatably connected to a barrel or a cap to form a rotating end, and the other end of the steel wire is fixedly connected to the barrel or the cap to form a fixed end. The rotating end is bent, and a bent part of the rotating end is perpendicular to an axial direction of the pen. The clamping structure is generally formed by bending a steel wire, and has a large elastic force. However, the clamping end of the clamping structure is formed by two steel wires in cooperation, which significantly increases processing and manufacturing costs. In addition, the clamping structure is rotatably connected to the barrel or the cap by the rotating end and is fixedly connected to the barrel or the cap by the fixed end, and the fixed end and the rotating end are located at different positions in the axial direction. Therefore, a force of clamping an object by the clamping structure is poor in balance.

Pen clips formed by a single steel wire are commercially available. However, present steel wire clips have small clamping force. Also, commercially available steel wire clips include a cylindrical structure, rotating around the pen for grip, making positioning difficult. In summary, an elastic clip made of a length of wire, that has a large clamping force, and that has low manufacturing and processing costs is required in the market.

### SUMMARY

An elastic wire clip assembly for a writing pen or the like is disclosed herein. In embodiments of the elastic wire clip assembly, an elastic clip is formed by bending a steel wire. The formation process for the elastic wire clip assembly requires significantly reduced processing and manufacturing costs and results in a clip that has a large elastic clamping force and high aesthetics. The elastic wire clip assembly requires simple processing and low material usage, so costs are significantly reduced. The elastic wire clip assembly has a simple assembly method and a stable structure after assembly.

In one embodiment, the invention provides an elastic wire clip assembly comprising an elastic wire clip having: at least one clamping section extending in a length direction of a pen and configured for clamping an object; at least one assembly section connected to a proximal end of the clamping section and configured for forming an assembly connection with a writing pen or the like; and at least one elastic transfer section connected to the assembly section, where the clamping section, the assembly section, and the elastic transfer section are formed by bending a single wire; and when an external force is applied to the clamping section to make the clamping section move relative to the writing pen, the elastic transfer section is pressed to deform, thereby assisting in providing an elastic force for restoring the clamping section.

Further, the one clamping section, the one assembly section, and the one elastic transfer section are located in a same plane.

Further, two clamping sections, two assembly sections, and two elastic transfer sections may be provided, where the two clamping sections are integrally connected.

Further, the assembly section may at least partially has a U shape.

Further, the elastic transfer section may have a U shape or a V shape; or the elastic transfer section and the assembly section may cooperate to form a U shape or a V shape.

Further, the assembly section and the elastic transfer section may sequentially include a first elastic force section connected to the clamping section, a first joint section capable of cooperating with a pen, a second elastic force section, a second joint section, and a third elastic force section, and the first joint section and the second joint section may both arc structures.

Further, an extension portion may be provided at a distal end of the elastic transfer section to make a horizontal height of the distal end of the elastic transfer section greater than or equal to a horizontal height of a top end of the assembly section.

Further, where a vertical height of the elastic transfer section is h and where a vertical height of the elastic wire clip is H, h/H may optimally range from ⅙ to ⅓; and where an outer diameter of the steel wire is D, D/h may optimally range from 1/12 to ⅙.

In other embodiments, an elastic wire clip assembly includes an elastic wire clip detachably connected to a writing pen or the like via a connecting member. The connecting member operates to provide a surface against which the elastic transfer section and assembly section can flex to create clipping fore. The connecting member has a hanging wall, a blocking wall arranged opposite to the hanging wall, and a mounting space located between the hanging wall and the blocking wall. The elastic wire clip includes at least one clamping section extending in a length direction of the pen, at least one assembly section connected to an end portion of the clamping section, and at least one elastic transfer section connected to an end portion of the assembly section, where the clamping section, the assembly section, and the elastic transfer section are formed by bending one wire, which may be made of steel. The assembly section is inserted into the mounting space from top to bottom. As the elastic transfer section is seated within the mounting space, an end portion of the elastic transfer section falls below the blocking wall and abuts against an outer wall of the writing pen (or similar device).

Further, the mounting space is defined by at least two opposite side walls that connect the hanging wall to the blocking wall.

Further, the hanging wall and the two opposite side walls cooperate to form a limiting groove, and the clamping section of the elastic wire clip is partially positioned in the limiting groove.

Further, a horizontal height of a top of the hanging wall is less than horizontal heights of tops of the two opposite side walls, and a height difference between the hanging wall and the two opposite side walls is greater than or equal to a diameter of the wire.

Further, one clamping section, one assembly section, and one elastic transfer section are provided; or two clamping sections, two assembly sections, and two elastic transfer sections are provided, where the two clamping sections are integrally connected to one another; and one or two connecting members are provided.

Further, the connecting member is directly attached to the writing body or to a mounting frame mounted on the writing body.

The elastic wire clip may be formed by bending one steel wire. Steel wire is a simple material, and the costs of processing molds are low. The clamping section of the elastic wire clip may be a single steel wire, so material usage, manufacturing costs, and size are reduced. The steel wire is bent to form the elastic transfer section. The elastic transfer section deforms when the clamping section is pulled outward. A restoring elastic force in the deformed elastic transfer section may assist in providing the elastic force for restoring the clamping section. This configuration resolves the problem of insufficient clamping force of a single-steel wire structure, so that the clamping force of the elastic wire clip is further increased while material usage is reduced. The layout of the clamping section, the assembly section, and the elastic transfer section provide a sufficient elastic clamping force, thereby achieving a good use effect.

In some cases, the single steel-wire may be doubled over to create a reinforced elastic wire clip structure. In this case, the elastic wire clip includes two elastic transfer sections that provide an assisting elastic force, so that the clamping force is greatly increased, the contact area with a clamped object is increased, and clamping is more stable to prevent rotation. An assembly of the elastic wire clip and the connection member is simple, stable, and aesthetically pleasing. The structure of the connection member provides a larger mounting space for the elastic clip so that the elastic transfer section can have a large deformation, thereby increasing the clamping force of the clamping section. In addition, the elastic transfer section can deform as soon as the clamping section is pulled outward, creating a simple operation.

Further, a bottom end of the clamping section is bent to form a mounting ring, the mounting ring is configured for being detachably connected to a rolling member, and the mounting ring, the clamping section, the assembly section, and the elastic transfer section are located in a same plane; and a positioning groove for the rolling member to fall in is provided in the outer wall of the writing body.

Further, a cross-section of the rolling member has an I shape; and the rolling member includes a left portion body and a right portion body that are butt-joined, and an outer diameter of a butt part of the rolling member is slightly less than or equal to an inner diameter of the mounting ring; or the rolling member has an integrally formed structure, and the mounting ring forms a notch portion for a middle part of the rolling member to be clamped in

The present invention further discloses a method for processing and assembling an elastic pen clip, including the following steps: bending a metal body in a first direction, where a first section body of the metal body forms a clamping section, and a second section body of the metal body is parallel or tends to be parallel to the clamping section, to make a part of the first section body cooperate with the second section body to form an assembly section; making the second section body of the metal body bend in a second direction to form a third section body, where the second direction is opposite to the first direction, and an angle is formed between the third section body and the second section body, to make at least a part of the third section body or the second section body cooperate with the third section body to form an elastic transfer section; and inserting the second section body and the third section body of the metal body into a writing body from top to bottom, making a distal end of the third section body abut against the writing body, and forming axial and radial limiting and fitting.

Further, the method includes the following steps: before a step of assembling and connecting the metal body and the writing body, repeating the foregoing operation on the same metal body, and performing bending to form two groups each including the clamping section, the assembly section, and the elastic transfer section, where the two clamping sections are integrally connected.

Further, the method includes the following step: making an end portion of the first section body of the metal body away from the second section body bend in a third direction to form a mounting ring, where the mounting ring, the first section body, the second section body, and the third section body are located in a same plane.

Further, the method includes the following step: mounting a rolling member on the mounting ring, where a part of an arc of the rolling member falls in a positioning groove in the outer wall of the writing body.

The beneficial effects of the present invention include the following: (1) The elastic wire clip is formed by bending one metal body, so that formation is easy and processing is convenient. The metal body is a steel wire or a steel sheet, which is a simple material, and the costs of processing molds are low. (2) The clamping section of the elastic wire clip may be a single steel wire or steel sheet, so that material usage is greatly reduced, and manufacturing costs are reduced. (3) The metal body is bent to form the elastic transfer section. The elastic transfer section deforms when the clamping section is pulled outward. A restoring elastic force in the deformed elastic transfer section may assist in providing the elastic force for restoring the clamping section, to resolve the problem of an insufficient clamping force of a single-steel wire or steel sheet structure, so that the clamping force of the elastic wire clip is further increased while material usage is reduced. (4) The elastic wire clip requires low material usage, so that while the costs are reduced, the size of the elastic wire clip is reduced. However, with the appropriate layout of the clamping section, the assembly section, and the elastic transfer section, a sufficient elastic clamping force can be provided, thereby achieving a good use effect. (5) The elastic wire clip may be a double-steel wire structure. The elastic wire clip uses two elastic transfer sections to provide an assisting elastic force, so that a clamping force is greatly increased, a contact area with a clamped object is increased, and clamping is more stable. (6) A cooperative structure of the elastic wire clip and the connection member is simple, the overall structure after assembly is stable, the elastic wire clip does not shake, and the overall aesthetics is high. (7) The structure of the connection member is appropriate, so that a larger mounting space can be provided to the elastic wire clip, and the elastic transfer section can have a large deformation, thereby increasing a clamping force of the clamping section. In addition, the elastic transfer section can deform as soon as the clamping section is pulled outward, so that operations are simple. (8) The assembly of the rolling member is simple, and an object can be clamped more smoothly through the cooperation between the rolling member and the clamping section, so that user experience is good. (9) Through the cooperation between the mounting frame and the connection member, while the mounting space of the elastic pen clip is expanded, mold costs are greatly reduced, thereby reducing manufacturing costs.

### BRIEF DESCRIPTION OF THE DRAWINGS

FIG. 1 is a front view of a first embodiment of an elastic wire clip illustrating certain dimensional relationships.

FIG. 2 is a front view the elastic wire clip of FIG. 1, but with a slightly extended elastic transfer section.

FIG. 3 is a perspective view of the elastic wire clip of FIG. 1 illustrating a force applied to a clamping section.

FIG. 4 is a partial perspective view of an upper portion of the elastic wire clip of FIG. 1.

FIG. 5 is a three-dimensional diagram of an elastic wire clip similar to that of FIG. 1, but wherein a body of the elastic wire clip is a steel sheet;

FIG. 6 is a front view of a writing pen equipped with an elastic wire clip assembly comprising a connection member.

FIG. 7 is a perspective view of the writing pen of FIG. 6.

FIG. 8 is a schematic structural diagram of an elastic wire clip and a rolling member.

FIG. 9 is a three-dimensional diagram of the rolling member of FIG. 8.

FIG. 10 is a cross-sectional view of the writing pen of FIG. 7 taken about section A in FIG. 7.

FIG. 11 is a perspective view of a connection member of FIG. 6.

FIG. 12 is a front perspective view of an assembly of the elastic wire clip and the connection member of FIG. 6.

FIG. 13 is a rear perspective view of the assembly of FIG. 12.

FIG. 14 is a cross-sectional view of the assembly of FIG. 12 taken about section B in FIG. 12.

FIG. 15 is a perspective view of another embodiment of an elastic wire clip having a reinforced wire structure.

FIG. 16 is a perspective view of a writing pen including the elastic wire clip of FIG. 15 and two connection members.

### DETAILED DESCRIPTION

The description that follows describes, illustrates and exemplifies one or more embodiments in accordance with its principles. This description is not provided to limit the disclosure to the embodiment(s) described herein, but rather to explain and teach the principles of the invention(s) disclosed herein in order to enable one of ordinary skill in the art to understand these principles and, with that understanding, be able to apply them to practice not only the embodiment(s) described herein, but also any other embodiment that may come to mind in accordance with these principles. The scope of the disclosure is intended to cover all such embodiments that may fall within the scope of the appended claims, either literally or under the doctrine of equivalents.

It should be noted that the drawings set forth herein are not necessarily drawn to scale and, in some instances, proportions may have been exaggerated to more clearly depict certain features. Positional references such as “upper” and “lower” may be used in regard to certain components to aid in understanding, but are not to be construed as limiting since these components and the drive units in which they are housed may be oriented in various ways depending on the application in which they are used and may also be oriented in various ways during the assembly process. As stated above, this specification is intended to be taken as a whole and interpreted in accordance with the principles of the invention(s) as taught herein and understood by one of ordinary skill in the art.

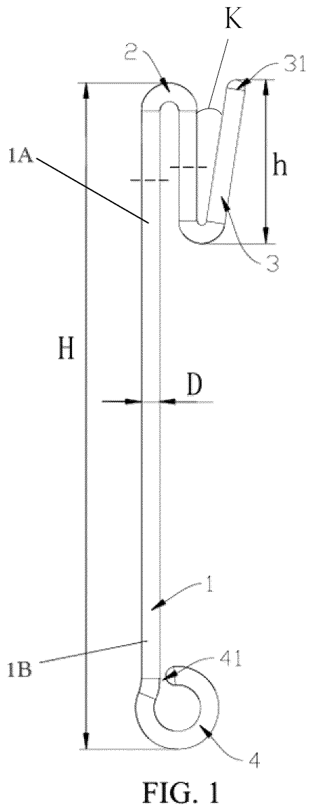

An elastic wire clip within the scope of the present invention is shown in FIGS. 1-3. As illustrated, the elastic wire clip includes a clamping section 1, an assembly section 2 connected to a proximal end portion 1A of the clamping section 1, and an elastic transfer section 3 connected to an end portion of the assembly section 2. The assembly section 2 is a U-shaped structure with an opening facing downward (or toward the distal end of the clamping section). The elastic transfer section 3 is a U-shaped structure with an opening facing upward (or away from the distal end of the clamping section).

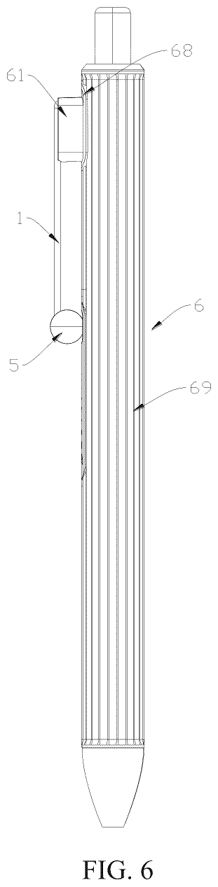

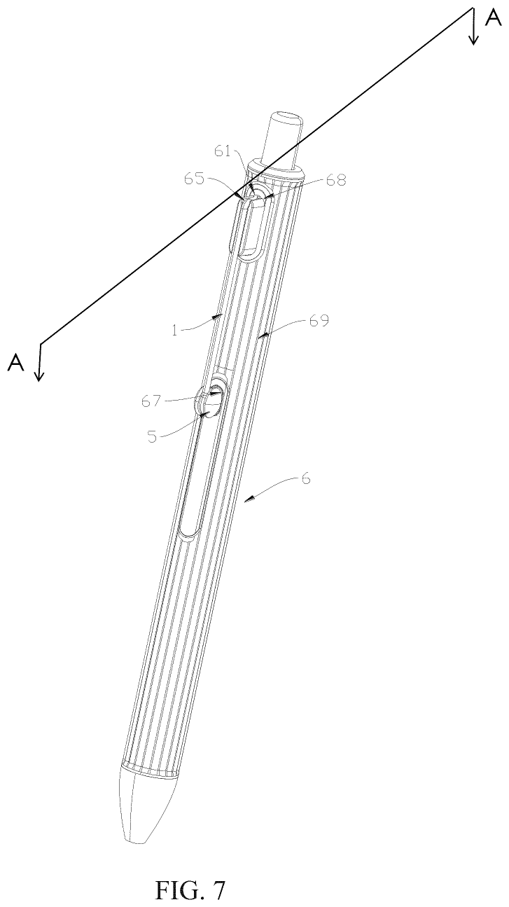

The clamping section 1 extends from its proximal end portion 1A where it connects to the assembly section to a distal end portion 1B. The distal end portion 1B may cooperate with an outer surface 6 of a pen or the like (see FIG. 6) to clamp an object in between. While the word “pen” is used herein, it will be understood that the inventive elastic wire clip could also be used with other marking instruments such as a highlighter, a stylus, a mechanical pencil, etc., as well as other similarly elongated items (pocket light, ruler, etc.) one might desire to clip to, for example, a shirt pocket. The object to be clamped may be a shirt pocket, but could also be a group of papers, a folder, a clipboard or other thin object that might be carried by a user. The structure of the clamping section 1 may be a straight-line structure or a curved structure.

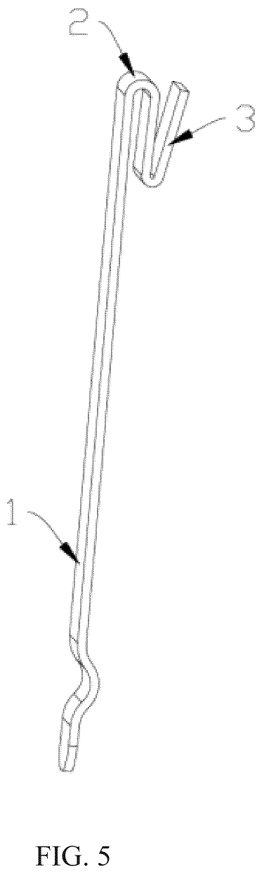

The clamping section 1, the assembly section 2, and the elastic transfer section 3 are located in a same plane, and may be formed by bending one steel wire. In other words, the elastic wire clip may be a single-steel wire structure and may be bent such that it forms a shape having only two dimensions (aside from the thickness of the wire). The wire used is typically made of steel due to steel's qualities of elasticity and malleability, though other metal and non-metal materials could be used. In alternative embodiments (not shown), an upper end of the elastic transfer section 3 may be wrapped around the outer surface 6 of a writing instrument (such as a pen) so to increase the contact area between the elastic transfer section 3 and the writing instrument. In such an embodiment, although the clamping section 1, the assembly section 2, and the elastic transfer section 3 are not located completely in the same plane, most of the clamping section 1, the assembly section 2, and the elastic transfer section 3 would be. In some embodiments, such as that shown in FIG. 5, a thinly-cut steel sheet may be used in lieu of steel wire. The term “elastic clip” as used herein could be formed of wire, a steel sheet, or a different material of similar proportions and elastic properties such as would be available and known to one of skill in the art. Also, unless noted otherwise, it will be understood that a thin steel sheet such as shown in FIG. 5 could be substituted for wire where an elastic wire clip is referenced.

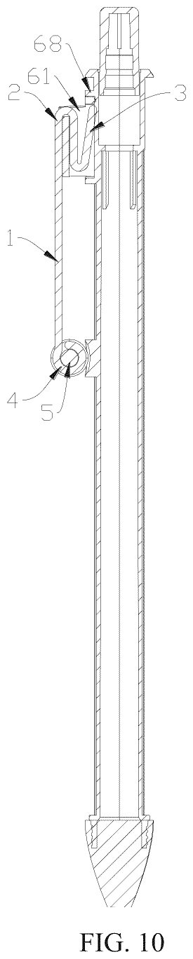

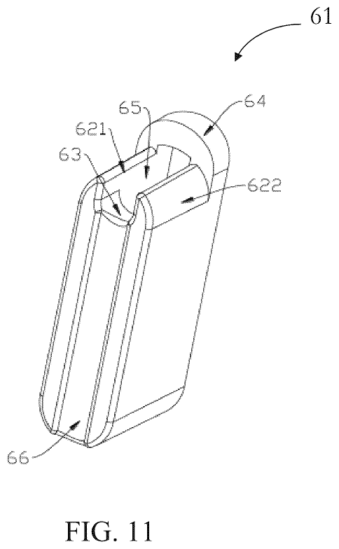

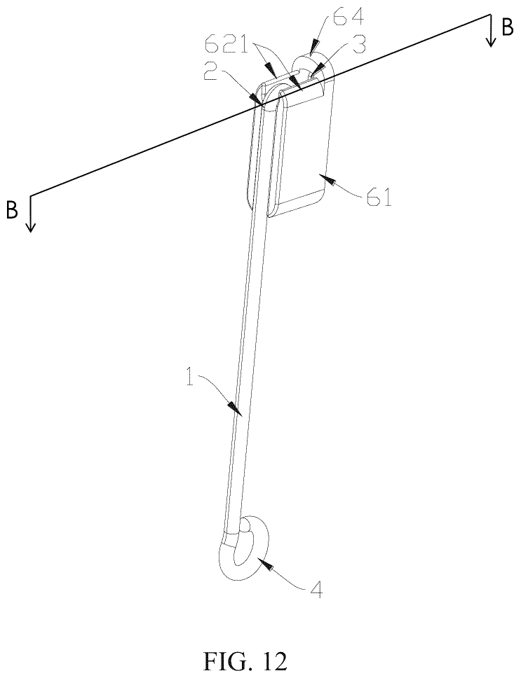

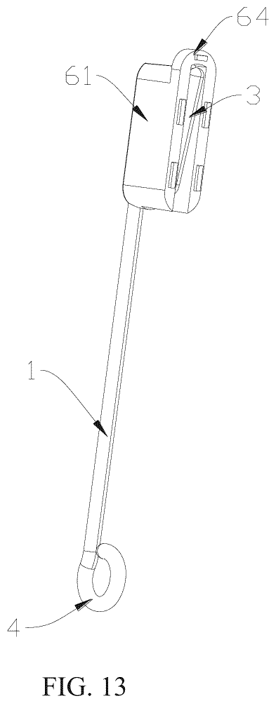

As discussed further below in association with FIG. 10 and FIG. 11, the elastic wire clip is part of an assembly that includes a connection member 61 attached to the outside of a pen body 6 or other rigid surface. The assembly section 2 and elastic transfer section 3 fit into the connection member 61, which is also rigid. Walls of the connection member 61 and the outer surface 6 of the pen provide surfaces for the elastic wire clip to bend against to generate a counter force to clip against an object.

Specifically, when an external force (separation force) is applied to make the distal end 1A of the clamping section 1 move in a direction away from the outer wall of the outer surface 6 of a pen (see as attached to a pen in FIG. 6—in other words, the distal end 1B of clamping section 1 as shown in FIG. 1 is pulled to the left), the elastic transfer section 3 is pressed in against the outer body 6 of the pen, and a lower portion of assembly section 2 is pressed outward against a hanging wall 63 of the connection member 61. As a result, the elastic transfer section 3 deforms (bends) and the upper opening (K) as shown in FIG. 6 is reduced in size. This provides a counteracting elastic force, pressing clamping section 1 back against the outer surface 6 of the pen to clamp the object that caused the separation force. In addition, because the elastic transfer section 3 has a restoring elastic force for expanding the upper opening of the U-shaped structure to an original state after being deformed by a force, the restoring elastic force can also assist in providing an elastic force for restoring the clamping section 1, so that the clamping section 1 and the outer wall of the pen exert a larger clamping force on the object, thereby resolving the problem of a poor clamping force of the clamping section 1 of a single-steel wire structure.

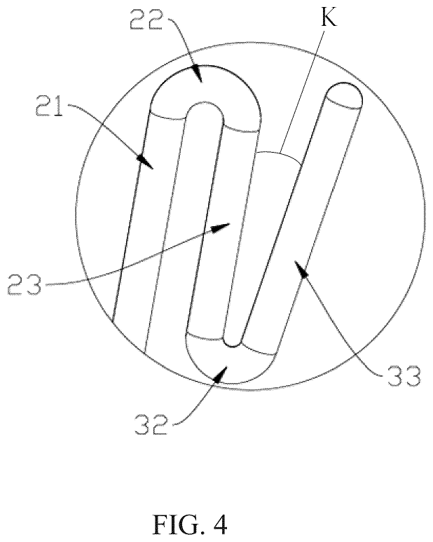

As shown in FIG. 4, the assembly section 2 and the elastic transfer section 3 sequentially include a first elastic force section 21, a first joint section 22, a second elastic force section 23, a second joint section 32, and a third elastic force section 33. In this embodiment, the first joint section 22 is a semi-arc structure with an opening facing downward (or toward the distal end 1A), and the second joint section 32 is a semi-arc structure with an opening facing upward (or away from distal end 1A). The first elastic force section 21 is connected to the clamping section 1, and the second elastic force section 23 is arranged in parallel to the first elastic force section 21. Therefore, when an external force is applied on the clamping section 1, the first elastic force section 21 may assist the clamping section 1 in providing an elastic force, and the second elastic force section 23 may cooperate with the third elastic force section 33 to provide support and a larger elastic force for the clamping section 1.

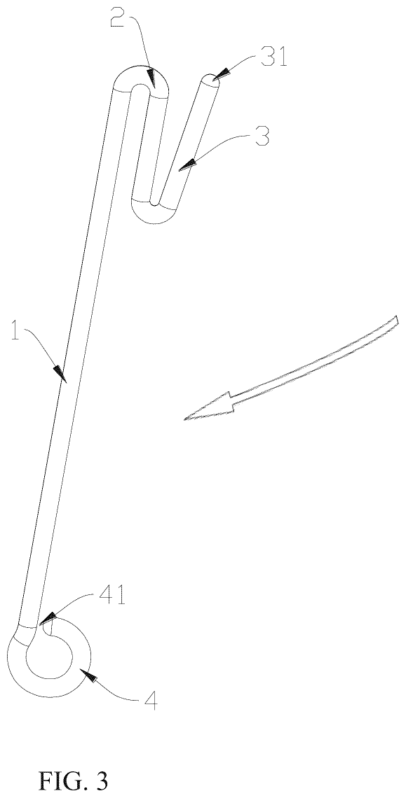

Specifically, when the clamping section 1 is rotated clockwise by an external force (using a direction shown in FIG. 3 as an example for description), the second elastic force section 23 deforms toward the third elastic force section 33 under the driving of the clamping section 1 and the angle (K) of the V-shaped structure between the second elastic force section 23 and the third elastic force section 33 decreases. When the external force is stopped, the deformation generated from the decrease in the angle of the V-shaped structure is restored to cooperate with the first elastic force section 21 to provide a large elastic force for the clamping section 1 so that the object can be firmly clamped.

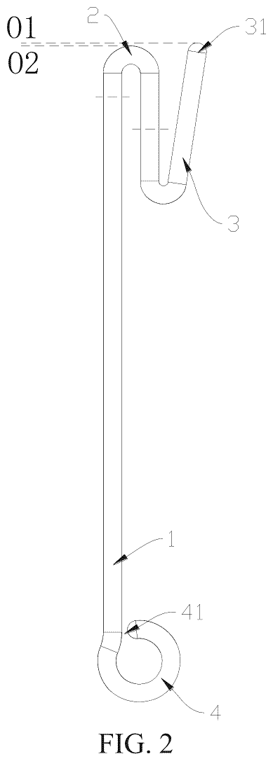

In the foregoing structure, the elastic transfer section 3 can be any length that enables the clamping elastic force of the clamping section 1 to be increased during restoration after pressing and deformation. In this embodiment, as shown in FIG. 2, an extension portion 31 is provided at a distal end of the elastic transfer section 3. The extension portion 31 is integrally connected to and concentric and coaxial with the rest of the elastic transfer section 3, so that a horizontal height of a distal end of the extension portion 31 is greater than or equal to a horizontal height of a top end of the assembly section 2. As shown in FIG. 2, the horizontal height of the distal end of the extension portion 31 is located at a position of O1, the horizontal height of the top end of the assembly section 2 is located at a position of O2, and O1 is located slightly above O2. In this case, the elastic transfer section 3 may be more deformed after being pressed by a force. Therefore, when the external force stops being applied, an elastic force generated from restoration of the elastic transfer section 3 is larger, and correspondingly, a larger clamping elastic force is provided for the clamping section 1. In other words, the further position O1 is above position O2, the further the increase in elastic force will be produced by deformation of the elastic transfer section 3.

As shown in FIG. 1, a vertical height of the elastic transfer section 3 is h, a vertical height of the elastic wire clip is H, and h/H ranges from ⅙ to ⅓. Preferably, h/H ranges from ⅕ to ¼. If an outer diameter of the steel wire is D, D/h ranges from 1/12 to ⅙. The foregoing value ranges ensure that the elastic transfer section 3 can be deformed sufficiently to assist in providing a large restoring elastic force for the clamping section 1. In addition, an overall size of the elastic wire clip is also relatively small compared to typical pen clips in the prior art, such that it provides an optimal elastic clamping force with minimum material usage and to facilitate processing and formation.

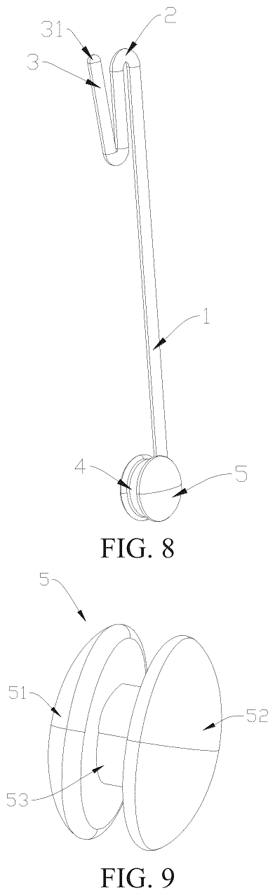

The distal end 1B of clamping section 1 is bent to form a mounting ring 4. The mounting ring 4 is configured to detachably connect to a rolling member 5 (See FIG. 8). The mounting ring 4, the clamping section 1, the assembly section 2, and the elastic transfer section 3 may be located in the same plane (e.g., may be bent such that they form a shape having only two dimensions aside from the thickness of the wire) and may be formed by bending one steel wire.

As shown in FIGS. 8 and 9, a cross-section of the rolling member 5 has an I shape. The rolling member 5 includes a left portion body 51 and a right portion body 52 that are center-joined, and an outer diameter of a center part 53 of the rolling member 5 is slightly less than or equal to an inner diameter of the mounting ring 4, so that after the left portion body 51 is inserted into the mounting ring 4, the right portion body 52 is inserted into the left portion body 51 to implement assembly and fixation.

The rolling member 5 may have an integrally formed structure instead of a split structure. In other words, the center part 53 may be integrally formed with the left portion body 51 and the right portion body 52. In this case, the mounting ring 4 forms a notch portion 41 for a middle part of the rolling member 5 to be clamped in. The notch portion 41 may also exist when the rolling member 5 has a split structure.

As shown in FIGS. 10 and 11, a writing pen includes an outer surface 6 and an elastic wire clip assembly. The elastic wire clip assembly comprises a connection member 61 connected to the outer surface 6 and an elastic wire clip detachably fitted in the connection member. The outer surface 6 includes a mounting frame 68. In this example embodiment, the mounting frame 68 is connected to the outer surface 6, and the connection member 61 is configured to be assembled and connected to the mounting frame 68. In other words, the outer surface 6 and the connection member 61 are arranged in a split manner. In alternative embodiments, the connection member 61 and the outer surface 6 may be part of the same integrally formed structure.

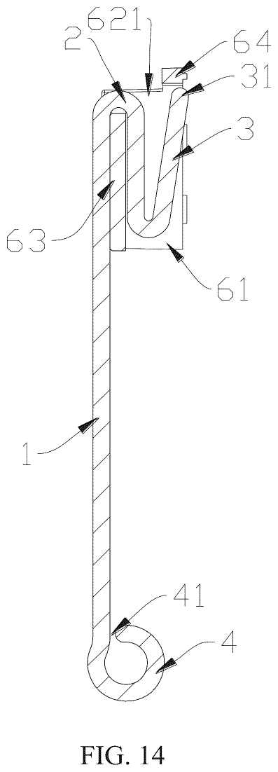

With reference to FIGS. 13 and 14, the connection member 61 includes two side walls 621 and 622 extending away from the outer surface 6, a hanging wall 63 located between the side walls 621 and 622, and a blocking wall 64 arranged opposite to the hanging wall 63 that separates the side walls 621 and 622 only at their top portions. The blocking wall seats against the outer surface 6 but does not extend down the length of the outer surface 6 very far. In contrast, blocking wall 64 extends down all the way to the bottom of the side walls 621 and 622. A top socket 65 is defined by the aforementioned walls. A distance between the side walls 621 and 622 is approximately equal to an outer diameter D (thickness) of a steel wire. Side walls 621, 622 are opposite each other and extend perpendicularly from outer surface 6. Hanging wall 63 and blocking wall 64 connect side walls 621, 622 together.

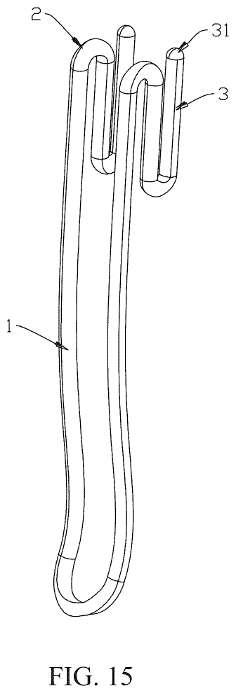

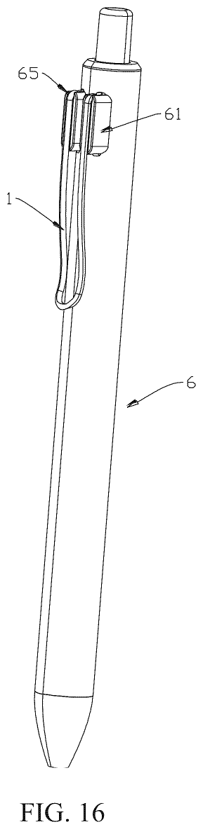

As shown in FIGS. 13 to 16, when the elastic wire clip assembly is to the outer surface 6, the assembly section 2 is inserted into the top socket 65 (behind hanging wall 63) from top to bottom. In this example embodiment, a clamping section 1 abuts against an outer surface of hanging wall 63. In addition, the elastic transfer section 3 slides against the outer surface 6, and enters the top socket 65 from top to bottom. As the elastic wire clip assembly is pushed further down, an end portion of the elastic transfer section 3 falls below the blocking wall 64, and the end portion of the elastic transfer section 3 abuts against the outer surface 6. In this manner, the blocking wall 64 is configured to stop the elastic wire clip assembly from moving upwards and detaching from the connection member 61. In other words, the blocking wall 64 operates to retain the elastic wire clip assembly in place within the top socket 65, and, thus, connected to the pen. Because the end portion of the elastic transfer section 3 abuts against the outer surface 6, when an external force is applied to pull the clamping section 1 outward, the elastic transfer section 3 may be pressed and deformed under the interaction among the clamping section 1, the assembly section 2, and the outer surface 6, such that the deformation and restoration can assist in providing an elastic force for restoring the clamping section 1.

The outer surface of hanging wall 63, together with side walls 621 and 622, cooperate to form a limiting groove 66. In other words, movement of the clamping section 1 and the assembly section 2 is partially limited by hanging wall 63 and side walls 621, 622 such that the clamping section 1 does not shift transversely, does not move toward the outer surface 6 further than the hanging wall 63, and is only pulled away from the outer surface 6 by an external force.

To further limit the movement range of the elastic wire clip assembly, the top of the hanging wall 63 is lower than the tops of side walls 621 and 622. Preferably, the top of the hanging wall 63 is lower by at least the outer diameter D of the steel wire. When a selected material is a steel sheet, the height difference is greater than or equal to a thickness of the steel sheet. In such case, the top of the elastic wire clip will be below the side walls and protected. In addition, the outer surface 6 defines a positioning groove 67 configured to receive the rolling member 5. The positioning groove 67 is configured to keep the rolling member 5 from deviating from a central axis of the outer surface 6.

A method for processing and assembling an elastic pen clip includes the following steps: bending a metal body in a first direction, where a first section body of the metal body forms a clamping section 1, and a second section body of the metal body is parallel or tends to be parallel to the clamping section 1, to make a part of the first section body cooperate with the second section body to form an assembly section 2; the first direction is a downward direction, the first section body is a left-side part, and the second section body is a right-side part. Then making the second section body of the metal body bend in a second direction to form a third section body, where the second direction is opposite to the first direction, and an angle is formed between the third section body and the second section body, to make at least a part of the third section body or the second section body cooperate with the third section body to form an elastic transfer section 3; and the second direction is an upward direction. Next, making an end portion of the first section body of the metal body away from the second section body bend in a third direction to form a mounting ring 4, where the mounting ring 4, the first section body, the second section body, and the third section body are located in a same plane; and the third direction is a rightward direction. Then, inserting the second section body and the third section body of the metal body into a writing body 6 from top to bottom, making a distal end of the third section body abut against the writing body 6, and forming axial and radial limiting and fitting; and mounting a rolling member 5 on the mounting ring 4, where a part of an arc of the rolling member 5 falls in a positioning groove 67 in the outer wall of the writing body 6.

FIGS. 17 and 18 depict an alternative embodiment elastic wire clip that includes two clamping sections 1, two assembly sections 2, and two elastic transfer sections 3, symmetrically arranged. The two clamping sections 1 are integrally connected. In this example embodiment, the elastic wire clip is formed by bending one steel wire. However, two ends of the steel wire of the steel wire are respectively bent to form separate clamping sections 1, assembly sections 2, and elastic transfer sections 3. Here, the clip is referred to as having a reinforced wire structure. In this case, a rolling member is not arranged at a bottom end of the elastic wire clip. Other features of this embodiment are the same as those described above. Correspondingly, two connection members 61 are provided on outer surface 6 and are symmetrically arranged to receive each of the two elastic transfer sections 3. The structure of each connection member 61 is the same as described above. The reinforced wire structure and the two connection members 61 together form a reinforced elastic wire clip assembly.

A method for processing and assembling an elastic pen clip includes the following steps: first, bending a steel wire in a first direction, where a first section body of the steel wire forms a clamping section 1, and a second section body of the steel wire is parallel or tends to be parallel to the clamping section 1, to make a part of the first section body cooperate with the second section body to form an assembly section 2; the first direction is a downward direction, the first section body is a left-side part, and the second section body is a right-side part. Then making the second section body of the steel wire bend in a second direction to form a third section body, where the second direction is opposite to the first direction, and an angle is formed between the third section body and the second section body, to make at least a part of the third section body or the second section body cooperate with the third section body to form an elastic transfer section 3; and the second direction is an upward direction. Next, repeating the foregoing operation on the same steel wire, and performing bending to form two groups each including the clamping section 1, the assembly section 2, and the elastic transfer section 3, where the two clamping sections 1 are integrally connected. Finally, inserting the second section body and the third section body of the steel wire into a writing body 6 from top to bottom, making a distal end of the third section body abut against the writing body 6, and forming axial and radial limiting and fitting, so that the two clamping sections, the two assembly sections, and the two elastic transfer sections are respectively assembled and connected to the writing body.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any equivalent thereof.

What is claimed is:

1. An elastic clip, comprising:
at least one clamping section configured to clamp an object against an outer surface of a writing instrument, the at least one clamping section having a proximal end and a distal end;
at least one assembly section having a first end attached to the proximal end of the at least one clamping section;
at least one elastic transfer section attached to a second end of the at least one assembly section;
wherein the at least one clamping section, the at least one assembly section, and the at least one elastic transfer section are formed from a single length of steel wire; and
wherein, when a separation force is applied to move the distal end of the at least one clamping section away from the body of the pen, the at least one elastic transfer section is configured to press against the body of the pen and bend, thereby providing an elastic force to counteract the separation force.

2. The elastic clip of claim 1, including only one clamping section, one assembly section, and one elastic transfer section, wherein the clamping section, the assembly section, and the elastic transfer section are located in a same plane.

3. The elastic clip of claim 1, including two clamping sections, two assembly sections, and two elastic transfer sections, wherein the two clamping sections are connected to one another at their distal ends.

4. The elastic clip of claim 3, wherein the two clamping sections, two assembly sections, and two elastic transfer sections are all formed from the same length of wire.

5. The elastic clip of claim 2, wherein the assembly section and the elastic transfer section sequentially comprise a first elastic force section, a first joint section, a second elastic force section, a second joint section, and a third elastic force section.

6. The elastic clip of claim 5, wherein the first elastic force section engages with the clamping section, and wherein the first joint section and the second joint section are both U-shaped structures.

7. The elastic clip of claim 2, further comprising an extension portion at a distal end of the elastic transfer section, wherein the distal end of the elastic transfer section extends further away from the distal end of the clamping section than does any portion of the assembly section.

8. The elastic clip of claim 1, wherein a vertical height of the elastic transfer section is h, a vertical height of the elastic clip is H, and h/H ranges from ⅙ to ⅓, and wherein an outer diameter of the steel wire is D and D/h ranges from 1/12 to ⅙.

9. An elastic clip assembly for a writing device, comprising:
a connection member comprising:
a hanging wall;
a blocking wall arranged opposite the hanging wall; and
a top socket located between the hanging wall and the blocking wall; and
an elastic clip comprising:
a clamping section having a proximal end and a distal end;
an assembly section having a first end and a second end, connected at the first end to the proximal end of the clamping section; and
an elastic transfer section connected to the second end of the assembly section;
wherein at least a portion of the assembly section is positioned within the top socket and behind the hanging wall such that an end portion of the elastic transfer section is retained below the blocking wall.

10. The elastic clip assembly of claim 9, wherein and the clamping section, the assembly section, and the elastic transfer section are formed of a single wire.

11. The elastic clip assembly of claim 9, wherein the hanging wall and the blocking wall are connected by two opposite side walls.

12. The elastic clip assembly of claim 11, wherein the hanging wall and the two opposite side walls define a limiting groove, and the limiting groove is configured to receive the clamping section.

13. The elastic clip assembly of claim 9, wherein a horizontal height of the hanging wall is less than a horizontal height of the two opposite side walls, and a height difference between the horizontal height of the hanging wall and the horizontal height of the two opposite side walls is greater than or equal to a diameter of the steel wire.

14. The elastic clip assembly of claim 9, wherein the elastic clip further comprises:
a second clamping section having a proximal end and a distal end;
a second assembly section having a first end and a second end, the second assembly section connected at the first end to the proximal end of the second clamping section; and
a second elastic transfer section connected to the second end of the second assembly section;
wherein the clamping section and the second clamping section are connected at their distal ends.

15. The elastic clip assembly of claim 9, wherein the distal end of the clamping section is formed into a mounting ring.

16. The elastic clip assembly of claim 15, further comprising a rolling member positioned over the mounting ring.

17. The elastic clip assembly of claim 16, wherein the connection member is attached to an outer surface of a writing instrument, and wherein the rolling member is configured to fit within a limiting groove formed in the outer surface.
